(19) United States
(12) Patent Application Publication
(10) Pub. No.: US 2009/0064068 A1
(43) Pub. Date: Mar. 5, 2009

(54) Method and Apparatus for Evaluating the Timing Effects of Logic Block Location Changes in Integrated Circuit Design

(75) Inventors: Alvan Wing Ng, Austin, TX (US); Taku Uchino, Yokohama-shi (JP)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/848,421

(22) Filed: Aug. 31, 2007

(51) Int. Cl. G06F 17/50

(52) U.S. Cl. 716/6

(57) ABSTRACT

An integrated circuit (IC) floorplan system includes an integration design system that executes IC floorplan software on a semiconductor die IC model. The IC floorplan software includes a timing tool database of the IC model. IC integrators utilize the IC floorplan software to evaluate logic block moves within the IC model. The IC floorplan software analyzes wire interconnect signal propagation time delays that result from prospective logic block moves with the IC model. The IC floorplan software reports back in real time whether or not a prospective move of a logic block from one location to another in the IC model will cause a timing failure due to a wire interconnect time delay exceeding a predetermined timing parameter.

### TECHNICAL FIELD OF THE INVENTION

The disclosures herein relate generally to information handling systems (IHSs), and more particularly, to a methodology and apparatus for evaluating performance characteristics relating to functional logical block movements within integrated circuits (ICs) during IC design.

### BACKGROUND

An information handling system (IHS) may include a processor for processing, handling, communicating or otherwise manipulating information. Modern IHSs often include integrated circuits (ICs) that incorporate several components integrated together on a common semiconductor die. Test systems may evaluate the functionality and performance characteristics of IC designs during the development process of the IC. A typical IC development process employs early design specifications that may include stringent requirements relating to the speed capabilities of the IC or other requirements. For example, a design requirement of a particular IC may demand that that the IC functions without failure at a predetermined clock frequency.

With often stringent requirements relating to the speed capability of ICs, designers must pay special consideration to the placement of components in the IC. Similarly, special attention is due with respect to the placement and routing of wire interconnects that couple together components in the IC. Other important parameters of an IC design may include IC floorplan or footprint constraints. Such floorplan constraints may include the overall size of the IC, heat dissipation management, noise immunity, power consumption and other such design constraints. One critical constraint on IC design is the IC floorplan layout of component groups on the semiconductor die. For example, after a functional design is complete, the IC floorplan layout or location of major component groups on the final IC floorplan may be a critical part of the overall IC development process.

Faster ICs translate to higher clock frequencies in IC development processes. Especially with constraints on higher clock frequencies, wire interconnect delays or trace delays in the IC become a dominant constraining factor in the IC development process. Wire interconnect delays, such as a signal propagation time delay between components and component groups on an IC, is a critical factor for IC designers. The ability for an IC designer to move major component groups and quickly determine the effect on the overall performance characteristics of the IC is of critical importance during the IC development process. Determining the wire interconnect signal timing changes that any particular component move causes to the overall functionality of an IC, may require a complex test strategy. Such test strategies may involve extensive testing with large application software in a simulation environment.

What is needed is a development method and apparatus that addresses the problems faced by integrated circuit IC designers as described above.

### SUMMARY

Accordingly, in one embodiment, a method of integrated circuit (IC) floorplanning is disclosed. The method includes generating, by an IC integration design system, a first IC floorplan model that includes a plurality of logic blocks and wire interconnects between the logic blocks, the plurality of logic blocks including first and second logic blocks that are located at respective first and second locations in the first IC floorplan model, the first IC floorplan model including a first wire interconnect between the first and second logic blocks. The method also includes evaluating, by the IC integration design system, the first IC floorplan model using an IC timing application to generate a timing database including timing parameters for the first and second logic blocks and the first wire interconnect therebetween. The method further includes receiving, by an IC floorplan application in the IC integration design system, the first IC floorplan model and the timing database. The method still further includes moving, by the IC floorplan application, the second logic block from the second location to a third location, thus generating a second IC floorplan model wherein the first wire interconnect is replaced with a second wire interconnect, wherein the second wire interconnect exhibits a different physical characteristic than the first wire interconnect. The method also includes generating, by the IC floorplan application, timing failure information in real time that indicates whether or not moving the second logic block from the second location to the third location to form the second IC floorplan model causes a timing failure due to a physical characteristic of the second wire interconnect.

In another embodiment, an IC floorplan computer program product is disclosed that includes instructions for receiving a first IC floorplan model that includes a plurality of logic blocks and wire interconnects between the logic blocks, the plurality of logic blocks including first and second logic blocks that are located at respective first and second locations in the first IC floorplan model, the first IC floorplan model including a first wire interconnect between the first and second logic blocks. The computer program product also includes instructions for evaluating the first IC floorplan model using an IC timing application to generate a timing database including timing parameters for the first and second logic blocks and the first wire interconnect therebetween. The computer program product further includes instructions for receiving the first IC floorplan model and the timing database. The computer program product still further includes instructions for moving the second logic block from the second location to a third location, thus generating a second IC floorplan model wherein the first wire interconnect is replaced with a second wire interconnect, wherein the second wire interconnect exhibits a different physical characteristic than the first wire interconnect. The computer program product also includes instructions for generating timing failure information in real time that indicates whether or not moving the second logic block from the second location to the third location to form the second IC floorplan model causes a timing failure due to a physical characteristic of the second wire interconnect.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of the disclosed IC floorplan system example that demonstrates a logic block move.

FIG. 2 is a timing diagram depicting selected signals in an embodiment of the disclosed IC floorplan method.

FIG. 3 is a flow chart that depicts process flow in one embodiment of the disclosed IC floorplan method.

FIG. 4 is a block diagram of an information handling system that employs the disclosed IC floorplan software methodology.

### DETAILED DESCRIPTION

In any particular IC, a special grouping and interconnection of transistors on the semiconductor die may form a component such as an AND gate, OR gate, flip flop, capacitor, or other component. A grouping of such components may form a component group or what is known as a logic block. Examples of logic blocks include multiplexers, encoders, shifters, adders, memory cell arrays, and many other logic blocks. IC development includes the work of IC designers who generate IC schematics and timing specifications as well as other design parameters from IC design requirements. IC development includes the work of IC integrator personnel or other entities who move logic blocks within the IC and develop timing trade-offs as well as other capabilities in the final IC product. IC developers include IC designers, IC integrators, and other entities that perform the IC development process.

The IC development process includes the creation of functional units by interconnecting or providing wire interconnects between various logic blocks in the IC design. Examples of functional units may include caches, arithmetical logic units (ALUs), processor cores and other functional units. The collection and interaction of the functional units together on the semiconductor die along with other devices determines the ICs functionality, capability, and performance characteristics.

Computer aided design (CAD) is a broad field that includes tools and methodologies that support the development and analysis of circuits including IC development. The well known “simulation program with integrated circuit emphasis” (SPICE) software, a development originally from UC Berkeley, is a common tool of IC designers. IC designers may use SPICE software to simulate analog timing characteristics of the IC design under development. IC designers may use SPICE or other software to test an IC design prior to production, often saving the costly process of building the IC, testing, and redesigning until good results are achieved. In one example, IC integrators use the output of the SPICE software model or collection of IC timing results as input into the IC integration process.

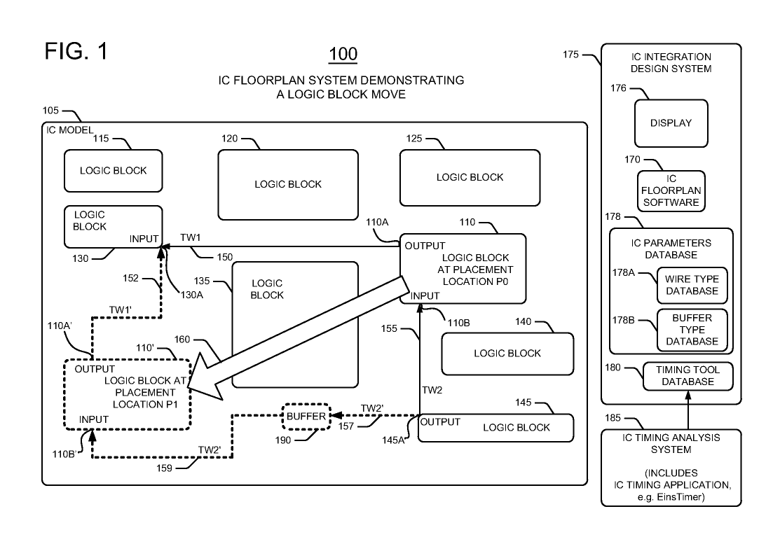

FIG. 1 shows an IC floorplan system 100 that demonstrates the disclosed logic block move method. An IC model 105 includes wire interconnects and multiple logic blocks. IC model 105 may represent a physical IC circuit. However, IC model 105 most typically remains as a virtual or simulation model within a test development system such as IC floorplan system 100 until the design is complete. IC model 105 includes a logic block 110 at a placement location P0 within the IC floorplan of IC model 105. Logic block 110 may be an encoder, shifter, multiplexer or other logic block function. IC model 105 includes other logic blocks such as a logic block 115, a logic block 120, and a logic block 125. IC model 105 also includes a logic block 130, a logic block 135, a logic block 140, and a logic block 145.

Logic block 110 generates an output signal, TW1, at logic block 110 output 110A. Logic block 110 output 110A couples to an input 130A of logic block 130 via wire interconnect 150. Wire interconnects provide the communication pathways between logic blocks of IC model 105. For this example, wire interconnect 150 provides the semiconductor pathway between the output 110A of logic block 110 and the input 130A of logic block 130. Wire interconnects between logic blocks in a typical IC, such as IC model 105, may number in the millions or even more. In this example a small number of wire interconnects are shown to demonstrate the disclosed IC floorplan methodology.

IC designers and IC integrators may measure the specific length of wire interconnect 150 in microns or micrometers. Wire interconnect lengths are a total of all the linear pathways that make up the complete wire interconnect structure in the IC, such as IC model 105. For example, wire interconnect 150 may route through IC model 105, measuring 200 microns in a horizontal direction from output 110A of logic block 110. From there, wire interconnect 150 may route 10 microns in a vertical direction to another layer to reach input 130A of logic block 130. The total length of wire interconnect 150 is thus 200+10 or 210 microns. IC developers often refer to the total length of such wire interconnects as the Manhattan Distance. The Manhattan Distance represents the total of all wire interconnect lengths of wire interconnect 150 as it routes along an orthogonal grid or (x,y,z) right angle coordinate system.

The total length of wire interconnect 150 is directly proportional to the propagation time delay of any wire interconnect signal communication. One such example is signal TW1 from the output 110A of logic block 110 to the input 130A of logic block 130. The wire interconnect length and the wire interconnect signal time delay are important considerations for IC integrators. Any particular wire interconnect length seen between logic blocks within IC model 105 demonstrate an arithmetic proportionality to wire interconnect signal time delay, as per Equation 1 below:

D=S*L EQUATION 1
wherein D=the wire interconnect signal delay
S=the wire interconnect coefficient
and L=the total length of the wire interconnect

Wire interconnect 150 provides a signal path, but effectively slows down the propagation of signal TW1, in accordance with the timing relation in Equation 1 above. D represents the propagation time delay of the signal TW1 in seconds from the logic block 110 output 110A to the input 130A of logic block 130. S represents a wire interconnect coefficient or constant that corresponds with the wire interconnect type in seconds per micron. The S term may be dependent upon the type of construction material of the wire interconnect, such as semiconductor doping material, film layer thickness, and other such physical factors. L is the distance or total length of wire interconnect 150. In one example, L is the physical measure of the total linear distance from the logic block 110 output 110A to the input 130A of logic block 130 in microns.

Logic block 145 generates an output signal, TW2, at logic block 145 output 145A. Logic block 145 output 145A couples to an input 110B of logic block 110, via wire interconnect 155. In this example, wire interconnect 155 provides the semiconductor pathway between the output 145A of logic block 145 and the input 110B of logic block 110. IC floorplan software 170 evaluates the timing impact on existing timing characteristics of IC model 105 by using the relationships shown with Equation 1 above. IC floorplan software 170 performs timing analysis? of IC model 105 without the need to implement actual physical changes within the IC model . . . IC integrators, using the IC floorplan software 170, may assess alternative IC floorplan solutions on the fly with nearly instant timing feedback. In one embodiment, the IC floorplan software 170 employs tool command language (TCL) and may run under ChipBench (an IBM floorplanning tool system), or other such test tool system. (ChipBench is a trademark of the IBM Corporation.)

An IC integrator may move or rearrange the relative positions of logic blocks within IC model 105. The IC integrator evaluates logic block moves to satisfy overall design requirements of IC model 105 with respect to IC floorplan layout constraints. Such IC floorplan layout constraints may include requirements relating to heat dissipation, power utilization, wire interconnect signal noise, etc. In one example, the IC integrator evaluates a movement of logic block 110 from its placement location P0 in the direction of move arrow 160 to another location. More particularly, the IC integrator evaluates the movement of logic block 110 at placement location P0 to a new placement location P1 as shown by logic block 110′ in IC model 105. Logic block 110′ is actually the same logic block as logic block 110, except that the location of logic block 110′ is now P1.

It is common for IC integrators to evaluate multiple and frequent IC floorplan changes for a particular IC. For example, IC integrators may make multiple logic block moves to evaluate different timing characteristics or timing trade offs of wire interconnect signals in an IC model. IC integrators evaluate IC model 105 modifications to improve wire interconnect lengths, wire interconnect routing, congestion, footprint area utilization, noise immunity and other IC design parameters.

IC model 105 is a simulation model that an IC integration design system 175 manipulates and manages. IC integration design system 175 includes the IC floorplan software 170. IC floorplan software 170 generates a simulation of the effects of moving logic block 110 at placement location P0 to logic block 110′ at placement location P1. In one embodiment, the IC floorplan software 170 uses a display 176 to provide information to an IC integrator or other entity during operation. In one embodiment, the IC floorplan software 170 operates within IC integration design system 175 and uses data from a timing tool database 180. The timing tool database 180 may contain important timing and other data that IC floorplan software 170 uses during operation. In one embodiment, the IC integration design system 175 includes an IC parameters database 178. IC parameters database 178 may include a wire type database 178A that stores wire interconnect parameters for use by IC floorplan software 170. IC parameters database 178 may further include a buffer type database 178B that stores buffer parameters.

In one embodiment, timing tool database 180 stores the results of an IC timing analysis system 185. In one embodiment, IC timing analysis system 185 includes a static IC timing analysis application, such as the EinsTimer timing tool system. (EinsTimer is a trademark of the IBM Corporation). The IC timing analysis system 185 may generate a node by node timing analysis of IC model 105. IC timing analysis system 185 couples to the timing tool database 180 of IC integration design system 175. IC integrators may utilize IC integration design system 175 with IC floorplan software 170 to provide support for logic block moves and the real time evaluation of wire interconnect changes.

One significant feature of logic block moves in the disclosed IC floorplan method is that the logic block itself does not change when it moves to a new placement location. In other words, logic block 110 and logic block 110′ are identical logic block structures with identical functionality. However, the IC integrator gives significant attention to wire interconnect changes as they relate to logic block moves. The IC integrator pays particular attention to wire interconnect length changes, and wire interconnect signal propagation time delay changes.

In one example, the IC integrator instructs IC floorplan software 170 to move logic block 110 to a new placement location P1. After the logic block move, logic block 110 becomes virtual logic block 110′. IC floorplan software 170 then modifies the original wire interconnect 150 to a replacement wire interconnect 152. IC integration design system 175 manages a timing tool database that includes predetermined delays for each wire interconnect. For example, predetermined delays provide the delay characteristics of wire interconnects for the current logic block placement locations of IC model 105. By using the relationship of Equation 1 above, IC floorplan software 170 calculates the D or delay of signal TW1 to TW1′. IC floorplan software 170 computes the change or TW1′ wire interconnect signal delay by evaluating the length change from the original wire interconnect 150 length to the replacement wire interconnect 152 length. IC floorplan software 170 modifies the results of previous timing models that may reside in timing tool database 180 and updates the delay of the signal TW1.

IC floorplan software 170 evaluates the TW1′ signal on wire interconnect 152 to determine if the signal meets all requirements for the current IC model 105 design. For example, TW1′ may cause a propagation time delay sufficiently large to miss the proper timing relationships that the input 130A of logic block 130 requires, thus causing a timing failure. IC developers may refer to such timing failures as timing breaks. The IC floorplan software 170 may determine that a specific wire interconnect change causes a wire interconnect signal propagation time delay and timing failure in IC model 105. The IC integrator may interrogate the IC floorplan software 170 on the fly to retrieve information regarding the timing failure in real time. IC floorplan software 170 may provide information to the IC integrator that identifies the particular wire interconnect, and thus the particular signal, that causes the timing failure. Multiple signals may fail or cause timing failures after IC floorplan software 170 evaluates any particular logic block move.

One important measure of a signal is a timing slack data measurement. Timing slack refers to the amount of time that a particular signal arrives at a target before a required arrival time (RAT) at that target. Arrival time is the time at which a particular signal such as TW1′ arrives at a target or receiving device, such as logic block 130. Simply put, the greater the slack, the safer the signal and the more robust the IC design becomes. In contrast, the smaller the slack, the closer the signal is to the point of not reaching the target device on time. Timing slack data can be an important resource in measuring single or large groups of wire interconnects and their respective wire interconnect signal characteristics before and after logic block moves. IC floorplan software 170 may keep timing slack data on important wire interconnects of IC model 105 in a local database such as timing tool database 180 for use during operation.

In one embodiment, IC floorplan software 170 determines if a particular timing signal, such as TW1′, is failing to meet timing slack requirements at input 130A of logic block 130. IC floorplan software 170 may report a wire interconnect signal timing failure immediately to the IC integrator during a logic block move evaluation. IC floorplan software 170 may also report near or close timing failures. For example, if signal TW1′ exhibits a value that is close to a timing failure, IC floorplan software 170 may so inform the IC integrator with respect to the timing slack data for that signal via a terminal or other interface (not shown).

In a manner similar to the modification of wire interconnect 150 during the move of logic block 110, IC floorplan software 170 also modifies wire interconnect 155 to accommodate the move of logic block 110. The IC integrator instructs IC floorplan software 170 to move logic block 110 at placement location P0 to a new logic block 110′ at placement location P1. Logic block 110′ is actually the same logic block as logic block 110, except that the location of logic block 110′ is P1. In this example, IC floorplan software 170 determines that the replacement wire interconnection that was previously wire interconnect 155 will require a buffer 190. Buffer 190 provides a signal repeater, or repeater stage capability to maintain signal strength necessitated by a wire interconnection length change. In one example, IC floorplan software 170 calculates the replacement for wire interconnect 155. IC floorplan software 170 uses the length of the replacement wire interconnect now connecting the output 145A of logic block 145 to the input 110B of logic block 110′. From that length, IC floorplan software 170 determines whether one or multiple buffers will maintain signal integrity and protect against timing failures.

In one example, IC floorplan software 170 determines that one buffer 190 will provide proper signal strength conditioning after the move of logic block 110 to location P1, as shown by move arrow 160. Logic block 145 generates output signal, TW2′, at output 145A. The output signal TW2′ from output 145A is a duplicate of the signal on wire interconnect 155 prior to the move of logic block 110 at placement location P0 to logic block 110′ at placement location P1. IC floorplan software 170 generates a wire interconnect 157 and a wire interconnect 159 to replace the original wire interconnect 155. Logic block 145 couples to buffer 190 via wire interconnect 157. Buffer 190 buffers or repeats the TW2′ signal on wire interconnect 159 to generate the signal TW2′ on wire interconnect 159. Buffer 190 couples to input 110B′ of logic block 110′ via wire interconnect 159.

In another example, IC floorplan software 170 may use an alternative approach to Equation 1 above for determining wire interconnect signal delay characteristics. IC floorplan software 170 may calculate wire interconnect signal time delay D by utilizing the delay characteristics of buffered wire approximations. Buffered wire approximations provide a buffer solution or calculation of floorplan wire interconnect buffer requirements. A buffer solution does not require the actual physical implementation of buffers, such as those of buffer 190. A typical IC integration logic block move may result in a large amount of buffer adds and deletes on multiple wire interconnects. The buffer solution includes buffered wire propagation time delay calculations for all wire interconnects affected by logic block moves. Wire time delay calculations are an update of the existing predetermined delays that IC integration design system 175 manages in timing tool database 180.

Buffer solutions that affect specific wire interconnects require a rebuild of the specific wire interconnects. Rebuilding or recalculating the specific wire interconnects may be a tedious task. For example, many constraints such as wire congestion are a factor during wire interconnect rebuild. Alternatively, IC floorplan software 170 may estimate wire propagation time delays by assuming proper buffering using buffered wire delay characteristics from a previous operation or calculation. IC floorplan software 170 may obtain buffered wire characteristics from circuit simulation sources. IC integrator interaction with IC floorplan software 170 simplifies and improves the speed of the timing evaluation process without keeping track of a specific buffer solution. For example, IC floorplan software 170 may calculate total wire interconnect delay D, in accordance with the timing relationship in Equation 2 below.

D=N*D1 EQUATION 2
wherein D=the wire interconnect signal delay
N=the total number of buffers
and D1=the delay of one buffer

In one embodiment, D1 is a quadratic function of the wire length of a wire interconnect driven by one buffer. For example, IC floorplan software 170 may calculate D1 in accordance with the wire interconnect relationship in Equation 3 below.

D1=A*L1*L1+B*L1+C EQUATION 3
wherein D1=the delay of one buffer
L1=the wire length driven by one buffer
A, B, and C=unique wire interconnect coefficients

L1 is the wire length of a wire interconnect of IC model 105, driven by one buffer. A, B, and C are unique wire interconnect coefficients that IC floorplan software 170 uses to determine the special physical characteristics of wire interconnects on IC model 105. The unique wire interconnect coefficients depend on wire interconnect width and spacing, buffer strength, buffer input capacitance, coupling conditions with other wire interconnects, and other physical parameters. If IC floorplan software 170 determines or uses a known value for L1, then Equation 4 below expresses the wire interconnect length, L.

L=L1*N EQUATION 4
wherein L=wire interconnect length
L1=the wire length driven by one buffer
N=the total number of buffers

IC model 105 exhibits a proportionality between delay D and wire interconnect length L. By replacing the N term in Equation 2 above with the N equivalence in Equation 4 above, IC integrators may formulate a new D term for use. For example, IC floorplan software 170 may calculate total wire interconnect delay D, in accordance with the timing relationship in Equation 5 below.

D=L*D1/L1 EQUATION 5
wherein D=the wire interconnect signal delay
L=wire interconnect length
D1=the delay of one buffer
L1=the wire length driven by one buffer

In the example shown in FIG. 1, IC floorplan software 170 determines the need for adding one buffer to wire interconnects 157 and 159. IC floorplan software 170 recalculates the timing of signal TW2, originally on wire interconnect 155 before the logic block move. In this case, IC floorplan software 170, bypasses the physical process of adding one buffer, namely buffer 190. IC floorplan software 170 determines the new total wire length of interconnects 157 and 159 and applies the unique wire interconnect coefficients A, B, and C to recalculate the new wire delay. In one example, IC floorplan software 170 calculates the delay of the new signal TW2′ on wire interconnects 157 and 159, per Equation 2 above. For this example, the delay D of wire interconnect signal from TW2 to TW2′=N times D1, or the delay of one buffer. IC floorplan software 170 modifies the results of previous timing models that may reside in timing tool database 180 and updates the delay D to the delay of the signal TW2 to form signal TW2′. D is the delay that IC floorplan software 170 adds to signal TW2 to transform it into signal TW2′.

In practice, multiple buffer adds and deletes affect delay characteristics on important wire interconnect signals of ICs such as IC model 105. IC floorplan software 170 maintains a store or database that provides the D1, L1, A, B, and C values of various wire interconnect and buffer types. In one embodiment, the disclosed method eliminates the need of an actual buffer placement step to provide fast timing evaluation feedback to the IC integrator. For example, IC floorplan software 170 may maintain the store of D1 values within buffer type database 178B. The IC floorplan software 170 performs a delay calculation, using Equation 2 above, on each wire interconnect that a logic block move within IC model 105 affects.

IC floorplan software 170 utilizes the historical knowledge of existing timing characteristics of each wire interconnect of IC model 105. For example, IC timing analysis system 185 may generate a previous EinsTimer timing analysis report of IC model 105. IC timing analysis system 185 then sends this EinsTimer timing analysis report to timing tool database 180. IC floorplan software 170 may access the EinsTimer timing analysis report of IC model 105 in future logic block move calculations. By utilizing the timing tool database 180, IC floorplan software 170 performs a substantially immediate pass/fail analysis of a logic block move, or multiple logic block moves, available to the IC integrator. The IC floorplan software 170 may determine that a particular logic block move creates one or more timing failures. If so, IC floorplan software 170 then displays on display 176 or otherwise outputs the details of the timing failure information to the IC integrator. The IC integrator may request information such as the specific wire interconnect or interconnects responsible for the failure. The IC integrator may also interrogate information such as timing slack data on a per wire interconnect basis.

In another embodiment of IC floorplan system 100, IC floorplan software 170 may modify the wire interconnect delay characteristic of a particular wire interconnect by changing the wire type or wire interconnect type. IC integration design system 175 may use the wire type database 178A to store wire type information. IC integration design system 175 determines wire type by the physical characteristics of the wire interconnect material and surrounding integrated circuit structure. For example, wire types may depend on the type of construction material of the wire interconnect, such as semiconductor doping material, film layer thickness, and other physical parameters.

IC floorplan software 170 maintains a store that provides the S values of various wire types. For example, IC floorplan software 170 may maintain the store of S values within wire type database 178A. Changing the wire type effectively changes the particular wire interconnect coefficient S as seen in Equation 1 above. For example, IC floorplan software 170 may modify the signal TW1′ delay characteristics of wire interconnect 152 by changing the wire type which in turn changes the wire interconnect coefficient, S, of Equation 1. IC floorplan software 170 may increase or decrease the wire interconnect signal delay value, D, of signal TW1′ by using a larger or smaller value of S in the selection of wire type, per Equation 1 above. This is an alternate method of changing the wire interconnect signal delay, D, for a particular wire interconnect instead of modifying the wire interconnect length.

In another embodiment of IC floorplan system 100, IC floorplan software 170 modifies the wire interconnect delay characteristic of a particular wire interconnect by changing the buffer type in series with the particular wire interconnect. Changing the buffer type effectively changes the particular buffer delay or D1 value (delay of one buffer), as seen in Equation 2 above. For example, IC floorplan software 170 may modify the signal TW2′ delay characteristics of wire interconnects 157 and 159, by changing the buffer 190 type and thus the buffer delay value, D1. IC floorplan software 170 may increase or decrease the D value of signal TW2′ by using a larger or smaller value of D1 in the selection of buffer type, per Equation 2 above. This is an alternate method of changing the wire interconnect signal delay value, D, for a particular wire interconnect.

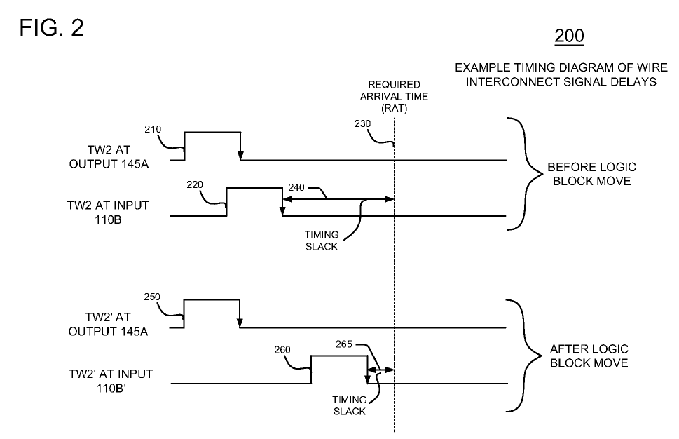

FIG. 2 shows multiple logic block wire interconnect waveforms over time for the IC model 105 of FIG. 1. The timing diagram of FIG. 2 further demonstrates the timing relationship of wire interconnect signals as a result of logic block moves that employ the disclosed IC floorplan methodology. Specifically, timing waveform 210 depicts the timing waveform of signal TW2 at output 145A of logic block 145 prior to the logic block move of logic block 110. Similarly, timing waveform 220 depicts the timing waveform of signal TW2 at input 110B of logic block 110 prior to any move. Waveform 220 accounts for the wire delay on wire interconnect 155 as shown by the shift in time to the right relative to waveform 210.

In one embodiment, IC timing analysis system 185 employs timing analysis software, such as EinsTimer timing analysis software. The EinsTimer software performs timing evaluation of the IC model 105 and generates a database of timing information for logic blocks and wire interconnects such as depicted in the waveforms of FIG. 2. Timing waveforms 210, and 220 depict representative waveforms as output by EinsTimer software. EinsTimer software or other timing analysis software stores timing information in the form of timing signal arrival time, propagation delay, slack data, and other data. IC integration design system 175 imports and maintains the timing information database for logic blocks and wire interconnect signals within the timing tool database 180 as a reference for any future logic block moves. In this manner, IC floorplan software 170 may maintain a record of the characteristics of the initial timing waveforms 210 and 220 of signal TW2 for future reference.

The critical point at which the falling edge of signal TW2 must reach a receiving device, such as logic block 110, is shown by the required arrival time (RAT) 230. The distance between the falling edge of timing waveform 220 and RAT 230 should be greater than zero. In other words, RAT 230 represents the latest point in time that the falling edge of signal TW2 can occur at the input 110B of logic block 110A and pass the timing requirements of IC model 105. If the falling edge of signal TW2 transitions to the right of the RAT 230, a timing failure occurs. As shown by the timing slack 240 in FIG. 2, timing waveform 220 or signal TW2 at input 110B meets the timing requirements of a pass condition test that IC floorplan software 170 performs. Timing waveform 220 further shows the propagation delay of timing waveform 210 across the total length of wire interconnect 155.

IC floorplan software 170 moves logic block 110 at placement location P0 to logic block 110′ at placement location P1 on IC model 105. IC floorplan software 170 calculates the total delay of the new path for signal TW2 on wire interconnect 155 and determines it to be signal TW2′ on wire interconnects 157 and 159. As seen in timing waveform 250 of FIG. 2, signal TW2′ at output 145A of logic block 145 is identical to timing waveform 210 or signal TW2 at output 145A of logic block 145. In other words, after a logic block move, the output wire interconnect signal of a logic block remains the same at the output (145A in this example) of the logic block that generates the output wire interconnect signal. However, the wire interconnect signal propagation due to an increase in wire interconnect length, change of buffers, modification of wire interconnect type, or other physical parameter change, will affect the timing delay of the waveform as seen at the input of a receiving logic block.

In the example of FIG. 1, signal TW2′ as seen at the input 110B′ of logic block 110′ is shown in FIG. 2 as timing waveform 260 after the logic block move. Although timing waveform 260 shows an increased propagation delay in comparison with the original timing waveform 250, the falling edge of timing waveform 260 transitions prior to the RAT 230. IC floorplan software 170 thus treats the timing slack 265 as a pass result or pass condition for signal TW2′ at input 110B′ of logic block 110′. Waveform 260 represents a pass result or condition under the timing analysis that IC floorplan software 170 conducts for signal TW2′. In this scenario, IC floorplan software 170 indicates a pass result or condition on display 176 for the wire interconnects 157 and 159 subsequent to the logic block move.

As described above, IC floorplan software 170 indicates a pass result with respect to the signal TW2 to signal TW2′ change that the logic block 110 move causes. However, in one embodiment, IC floorplan software 170 may also evaluate all other wire interconnects in IC model 105 and thus wire interconnect signals at the same time. If one or more wire interconnect signal fails to meet the positive requirements of each timing slack data calculation, IC floorplan software 170 will determine and output on display 176 the logic block move as a fail. IC floorplan software 170 identifies the particular wire interconnects and wire interconnect signals that exhibit timing failures after a logic block move. IC floorplan software 170 determines and displays each timing slack data value for each respective wire interconnect signal timing failure. Displaying this information in real time in this manner allows IC integrators to quickly evaluate and modify their logic block moves, to experiment with other logic moves and to re-test such additional moves until the evaluation achieves a pass result.

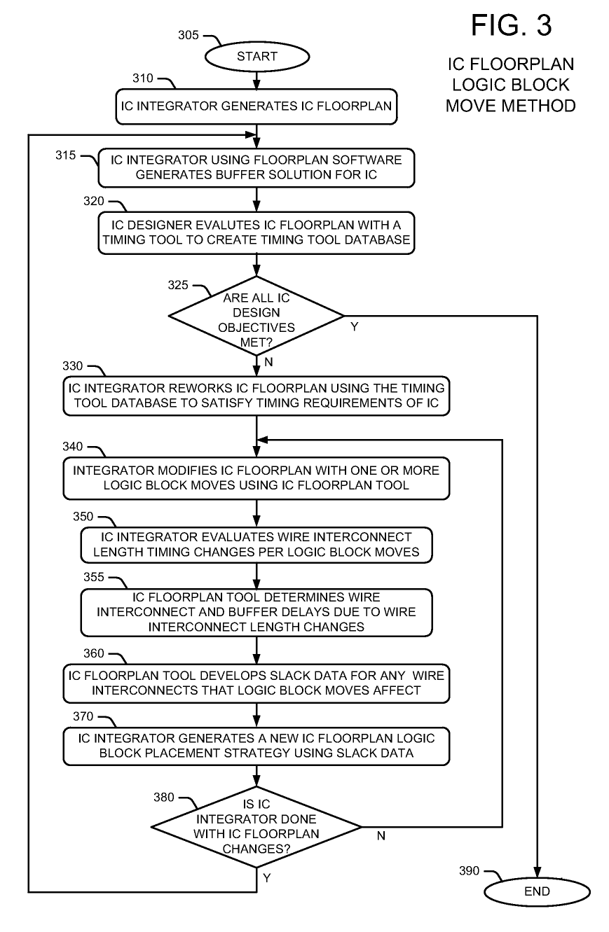

FIG. 3 is a flowchart that depicts the steps of an IC floorplan methodology that includes timing analysis of wire interconnects related to logic block moves. The IC floorplan method begins at start block 305. The IC integrator generates an IC floorplan, as per block 310. For example, the IC floorplan is a virtual IC floorplan layout of all logic blocks of an IC, such as IC model 105, and the wire interconnects between all logic blocks. The virtual layout is a soft or electronic copy of a potential physical IC, such as IC model 105. In IC development, IC integrators generate and evaluate many virtual versions of the final IC before creating the final physical IC itself.

The IC integrator uses the IC floorplan software 170 to generate a buffer solution for IC model 105, as per block 315. IC floorplan software 170 calculates the buffer requirements between logic blocks of IC model 105. IC floorplan software 170 identifies the number and types of buffers that each wire interconnect requires in IC model 105. IC floorplan software 170 may store the number and buffer type requirements in IC parameters database 178. For example, buffer 190 may be the buffer requirement for the wire interconnects 157 and 159 corresponding to signal TW2′ in IC model 105 upon physical implementation of the buffer solution.

An IC designer evaluates the IC model 105 IC floorplan with a timing tool to create a timing database, as per block 320. A timing tool, such as IC timing analysis system 185 running EinsTimer timing analysis software evaluates the timing characteristic of IC model 105. IC timing analysis system 185 may generate timing information database data such as arrival time, propagation delay, and timing slack data on each logic block and wire interconnect of IC model 105. In one embodiment, the IC timing analysis system 185 may generate a timing database of each logic block if not already done prior to the latest IC model 105 design. The timing tool information database allows the IC designer to analyze the current design of IC model 105 against design specifications.

Using timing information that the IC timing analysis system 185 produces, the IC designer reviews the timing information database against design requirements to determine if all IC design objectives are met, as per decision block 325. If all design objectives are not met, the IC integrator reworks the IC floorplan using IC floorplan software 170 and the timing tool database 180 as a reference to satisfy the timing requirements of IC model 105, as per block 330. IC floorplan software 170 may import the timing tool database 180 data from IC timing analysis system 185. For example, the IC integrator may determine that specific wire interconnect lengths do not meet the timing requirements of a particular IC design, such as those of IC model 105.

The IC integrator modifies the IC floorplan with one or more logic block moves using the IC floorplan software 170, as per block 340. Logic block moves, such as those depicted in FIG. 1 allow the IC integrator the option of making timing adjustments in the IC model 105 IC floorplan without affecting the timing characteristics of existing logic blocks. IC floorplan software 170 performs the logic block moves that the IC integrator requests on the IC model 105 and automatically calculates the wire interconnect changes that result from these moves. The IC integrator evaluates the wire interconnect lengths and wire interconnect signal timing changes that result from logic block moves, as per block 350. The IC integrator may interrogate IC floorplan software 170 for logic block move results via a terminal (not shown) or other medium. The IC integrator may review the wire interconnect signal timing changes that result from the logic block moves of block 340 to evaluate the effectiveness of each logic block move.

The IC floorplan software 170 determines wire interconnect and buffer delays due to wire interconnect length changes in IC model 105, as per block 355. The IC floorplan software 170 develops timing slack data, such as timing slack 265, for all wire interconnects that any logic block affects, as per block 360. Timing slack data for wire interconnects allows the IC integrator to look for problem areas in the IC model 105 IC floorplan layout. Small timing slack data values may indicate wire interconnects that are near the limit of their acceptable lengths that still provide wire interconnect signals in a timely manner. Wire interconnects near their length limits may require logic block moves or other changes to provide an improved robustness of design for IC model 105 and to avoid timing failures.

The IC integrator generates a new IC floorplan logic block placement strategy using timing slack data, as per block 370. The IC integrator determines if the IC floorplan changes are complete and the logic block move results are acceptable, as per decision block 380. If the IC integrator is done with the IC floorplan changes, the IC floorplan method continues and process flow continues back to block 315. In this case, IC floorplan software 170 regenerates any buffer solution for wire interconnects that any logic block move affects in IC model 105. IC floorplan software 170 regenerates the buffer solutions to physically implement the buffer changes. The IC designer may then evaluate the timing result changes again as per block 320 and flow continues. However, if the IC integrator is not done with IC floorplan changes at decision block 380, then flow continues back to block 340, wherein the IC integrator continues to make modifications to the floorplan. If all IC design objectives are met per decision block 325, then the IC floorplan method of FIG. 2 ends, as per end block 390.

In one embodiment of the disclosed IC floorplan method, IC integrators may evaluate logic block moves relative to a scaling of an existing IC, such as IC model 105. For example, migration of IC model 105 to a new semiconductor technology may require the shrinking of the overall IC model 105 footprint or semiconductor die area. However, it is often found that not all components shrink in the same proportion. For example, arrays do not scale well in dimensions and wires do not scale well in performance. These constraints lead to rework of the IC floorplan to fix timing problems and to better optimize the usage of valuable semiconductor area by logic blocks in the IC floorplan.

IC integrators may use the IC floorplan software 170 to modify the characteristics of logic blocks and recalculate the wire interconnection buffer delays between logic blocks on IC model 105. Working with IC floorplan software 170, IC integrators may rearrange logic block placement, wire interconnect type, buffer type, and other physical parameters of IC model 105. The IC floorplan software 170 may identify problem areas such as wire interconnect signal timing failures and other problems that the IC integrator may evaluate and repair.

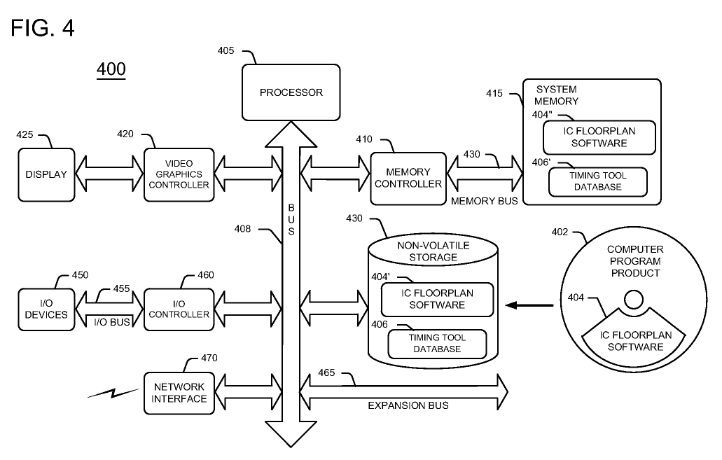

FIG. 4 shows an information handling system (IHS) 400 that IC integration design system 175 may employ as an IC floorplan layout tool. In that case, such an IHS carries out the functional blocks of the flowchart of FIG. 3 that apply to the IC integration design system. IHS 400 includes a computer program product 402, such as a media disk, media drive or other media storage. IHS 400 includes IC floorplan software 404 that enables IC integrators to evaluate proposed logic block moves in ICs and the resultant wire interconnect signal changes in real time. IC floorplan software 404 of FIG. 4 corresponds to IC floorplan software 170 of FIG. 1. IHS 400 includes a processor 405 that couples to a bus 408. A memory controller 410 couples system memory 415 to bus 408. A video graphics controller 420 couples display 425 to bus 408. IHS 400 includes nonvolatile storage 430, such as a hard disk drive, CD drive, DVD drive, or other nonvolatile storage that couples to bus 408 to provide IHS 400 with permanent storage of information. Nonvolatile storage 430 is a form of data store. I/O devices 450, such as a keyboard and a mouse pointing device, couple via I/O bus 455 and I/O controller 460 to bus 408. One or more expansion busses 465, such as USB, IEEE 1394 bus, ATA, SATA, PCI, PCIE and other busses, couple to bus 408 to facilitate the connection of peripherals and devices to IHS 400. A network interface 470 couples to bus 408 to enable IHS 400 to connect by wire or wirelessly to other network devices. IHS 400 may take many forms. For example, IHS 400 may take the form of a desktop, server, portable, laptop, notebook, or other form factor computer or data processing system. IHS 400 may also take other form factors such as a personal digital assistant (PDA), a gaming device, a portable telephone device, a communication device or other devices that include a processor and memory.

IHS 400 may employ a compact disk (CD), digital versatile disk (DVD), floppy disk, external hard disk or virtually any other digital storage medium as medium 402. Medium 402 stores software including IC floorplan software 404 thereon. A user or other entity installs software such as IC floorplan software 404 on IHS 400 prior to usage of this test system application. The designation, IC floorplan software 404′, describes IC floorplan software 404 after installation in non-volatile storage 430 of IHS 400. The designation, IC floorplan software 404″, describes IC floorplan software 404 after IHS 400 loads the test system software into system memory 415 for execution.

A timing tool database 406 is a database of timing characteristics for use by IC floorplan software 404. Timing tool database 406 corresponds to timing tool database 180 of FIG. 1. Timing tool database 406 loads from another test system or other entity prior to execution of IC floorplan software 404. The designation, timing tool database 406′, describes the timing tool database 406 after IHS 400 loads the IC floorplan software 404 into system memory 415 for execution. Timing tool database 406 provides a database of characteristics for ICs, such as IC model 105 for use during logic block move wire interconnect evaluations.

Those skilled in the art will appreciate that the various structures disclosed, such as IC floorplan 170 and timing tool database 180 can be implemented in hardware or software. Moreover, the methodology represented by the blocks of the flowchart of FIG. 3 may be embodied in a computer program product, such as a media disk, media drive or other media storage such as computer program product medium 402 of FIG. 4.

In one embodiment, the disclosed methodology is implemented as an IC floorplan software application 170 or 404, namely a set of instructions (program code) in a code module which may, for example, be resident in the system memory 415 of IHS 400 of FIG. 4. Until required by IHS 400, the set of instructions may be stored in another memory, for example, non-volatile storage 430 such as a hard disk drive, or in a removable memory such as an optical disk or floppy disk, or downloaded via the Internet or other computer network. Thus, the disclosed methodology may be implemented in a computer program product for use in a computer such as IHS 400. It is noted that in such a software embodiment, code which carries out the functions described in the flowchart of FIG. 3 may be stored in RAM or system memory 415 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps

The foregoing discloses methodologies wherein an IC integration design system employs IC floorplan software to provide IC integrator personnel with real time feedback with respect to logic block moves and their effect on wire interconnect signal delays.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of integrated circuit (IC) floorplanning, comprising:
generating, by an IC integration design system, a first IC floorplan model that includes a plurality of logic blocks and wire interconnects between the logic blocks, the plurality of logic blocks including first and second logic blocks that are located at respective first and second locations in the first IC floorplan model, the first IC floorplan model including a first wire interconnect between the first and second logic blocks;
evaluating, by the IC integration design system, the first IC floorplan model using an IC timing application to generate a timing database including timing parameters for the first and second logic blocks and the first wire interconnect therebetween;
receiving, by an IC floorplan application in the IC integration design system, the first IC floorplan model and the timing database;
moving, by the IC floorplan application, the second logic block from the second location to a third location, thus generating a second IC floorplan model wherein the first wire interconnect is replaced with a second wire interconnect, wherein the second wire interconnect exhibits a different physical characteristic than the first wire interconnect; and
generating, by the IC floorplan application, timing failure information in real time that indicates whether or not moving the second logic block from the second location to the third location to form the second IC floorplan model causes a timing failure due to a physical characteristic of the second wire interconnect.

2. The method of claim 1, wherein the physical characteristic is one of the length of the second wire interconnect, the wire type of the second wire interconnect, the propagation time delay of the second wire type and the buffer type of the second wire interconnect.

3. The method of claim 1, wherein the generating step includes determining the propagation time delay exhibited by the second wire interconnect.

4. The method of claim 3, wherein the generating step includes indicating a timing failure if the propagation time delay exhibited by the second wire interconnect exceeds a required arrival time (RAT) specification of the second logic block.

5. The method of claim 1, further comprising displaying, by a display in the IC integration design system, the timing failure information in real time in response to an integrator commanding the IC floorplan application to move the second logic block from the second location to the third location to form the second IC floorplan model.

6. The method of claim 1, wherein in response to a timing failure, the IC floorplan application generates timing failure information that includes an indication of the location of the timing failure in the IC floorplan model.

7. The method of claim 3, wherein the generating step further includes determining, by the IC floorplan application, a wire length of the second wire interconnect between the first and second logic blocks when the second logic block is moved to the third location, the generating step further including determining a buffered wire delay value for the second wire interconnect based on the wire length of the second wire interconnect in the second IC floorplan model.

8. The method of claim 3, further comprising accessing, by the IC floorplan application, a wire type database to determine the propagation time delay of the second wire interconnect.

9. The method of claim 8, further comprising modifying a wire type of the first wire interconnect to form the second wire interconnect that exhibits a predetermined propagation time delay.

10. The method of claim 3, further comprising accessing, by the IC floorplan application, a buffer type database to determine a buffered wire delay associated with the length of the second wire interconnect.

11. The method of claim 10, further comprising modifying a buffer type of the first wire interconnect to form the second wire interconnect that exhibits a predetermined propagation time delay.

12. The method of claim 1, wherein the timing failure information further includes timing slack information.

13. An IC floorplan computer program product, comprising:
instructions for receiving a first IC floorplan model that includes a plurality of logic blocks and wire interconnects between the logic blocks, the plurality of logic blocks including first and second logic blocks that are located at respective first and second locations in the first IC floorplan model, the first IC floorplan model including a first wire interconnect between the first and second logic blocks;
instructions for evaluating the first IC floorplan model using an IC timing application to generate a timing database including timing parameters for the first and second logic blocks and the first wire interconnect therebetween;
instructions for receiving the first IC floorplan model and the timing database;
instructions for moving the second logic block from the second location to a third location, thus generating a second IC floorplan model wherein the first wire interconnect is replaced with a second wire interconnect, wherein the second wire interconnect exhibits a different physical characteristic than the first wire interconnect; and
instructions for generating timing failure information in real time that indicates whether or not moving the second logic block from the second location to the third location to form the second IC floorplan model causes a timing failure due to a physical characteristic of the second wire interconnect.

14. The computer program product of claim 13, wherein the physical characteristic is one of the length of the second wire interconnect, the wire type of the second wire interconnect, the propagation time delay of the second wire type and the buffer type of the second wire interconnect.

15. The computer program product of claim 13, wherein the instructions for generating include instructions for determining the propagation time delay exhibited by the second wire interconnect.

16. The computer program product of claim 15, wherein the instructions for generating include instructions for indicating a timing failure if the propagation time delay exhibited by the second wire interconnect exceeds a required arrival time (RAT) specification of the second logic block

17. The computer program product of claim 13, further comprising instructions for displaying the timing failure information in real time in response to an integrator commanding the IC floorplan application to move the second logic block from the second location to the third location to form the second IC floorplan model.

18. The computer program product of claim 15, wherein the instructions for generating further includes instructions for determining a wire length of the second wire interconnect between the first and second logic blocks when the second logic block is moved to the third location, the instructions for generating further including instructions for determining a buffered wire delay value for the second wire interconnect based on the wire length of the second wire interconnect in the second IC floorplan model.

19. The computer program product of claim 15, further comprising instructions for accessing a wire type database to determine the propagation time delay of the second wire interconnect.

20. The computer program product of claim 15, further comprising instructions for accessing a buffer type database to determine a buffered wire delay associated with the length of the second wire interconnect.

21. An integrated circuit (IC) design system, comprising:
an IC timing application that receives a first IC floorplan model that includes a plurality of logic blocks and wire interconnects between the logic blocks, the plurality of logic blocks including first and second logic blocks that are located at respective first and second locations in the first IC floorplan model, the first IC floorplan model including a first wire interconnect between the first and second logic blocks, wherein the IC timing application evaluates the first IC floorplan model to generate a timing database including timing parameters for the first and second logic blocks and the first wire interconnect therebetween; and
an IC floorplan application that receives the first IC floorplan model and the timing database, the IC floorplan application moving the second logic block from the second location to a third location, thus generating a second IC floorplan model wherein the first wire interconnect is replaced with a second wire interconnect, wherein the second wire interconnect exhibits a different physical characteristic than the first wire interconnect, the IC floorplan application further generating timing failure information in real time that indicates whether or not moving the second logic block from the second location to the third location to form the second IC floorplan model causes a timing failure due to a physical characteristic of the second wire interconnect.

22. The integrated circuit (IC) design system of claim 21, wherein the physical characteristic is one of the length of the second wire interconnect, the wire type of the second wire interconnect, the propagation time delay of the second wire type and the buffer type of the second wire interconnect.

23. The integrated circuit (IC) design system of claim 21, wherein the IC floorplan application indicates a timing failure if the propagation time delay exhibited by the second wire interconnect exceeds a required arrival time (RAT) specification of the second logic block.

24. The integrated circuit (IC) design system of claim 21, further comprising a display that displays the timing failure information in real time in response to an integrator commanding the IC floorplan application to move the second logic block from the second location to the third location to form the second IC floorplan model.

25. The integrated circuit (IC) design system of claim 21, wherein the timing failure information includes timing slack information.
